(19) United States
(12) Patent Application Publication
(10) Pub. No.: US 2009/0105852 A1
(43) Pub. Date: Apr. 23, 2009

(54) Control loop for regulating a process, in particular a combustion process

(75) Inventors: Franz Wintrich, Essen (DE); Volker Stephan, Hupstedt (DE); Steffen Muller, Bodelwitz (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Powitec Intelligent Technologies GmbH, Essen (DE)

(21) Appl. No.: 12/287,525

(22) Filed: Oct. 10, 2008

(30) Foreign Application Priority Data
Oct. 12, 2007 (EP) 07 019 982.3

(51) Int. Cl. G05B 13/04; G06N 3/02; G06F 15/18

(52) U.S. Cl. 700/29; 706/21; 700/274

(57) ABSTRACT

A control loop, which is for regulating a process in a plant having a controlled system, comprises: at least one measuring device for recording observation values of the controlled system, at least one adjustment device for acting on the controlled system in response to the adjustment device being controlled by way of action values, and a regulator. The regulator is operative to provide the action values. The regulator being operative to provide the action values comprises the regulator being adapted for: predicting, by way of a process model and at least one probability distribution of the observation values, a set of distributions of probable future states of the system; evaluating the set of distributions of probable future states of the system using target values and/or distributions of the target values; and selecting at least one probability distribution of action values.

### RELATED APPLICATION

The present application claims priority to EP 07 019 982.3, which was filed Oct. 12, 2007. The entire disclosure of EP 07 019 982.3 is incorporated herein by reference.

### TECHNICAL FIELD

The present disclosure relates to a control loop for regulating a process, in particular a combustion process, in a plant, in particular a power-generating plant, a waste-treatment/incineration plant or a cement plant, having: a controlled system; at least one measuring device that records observation values of the controlled system; at least one adjustment device that is controlled by action values and acts on the controlled system; and a regulator that is connected to the measuring device and the adjustment device, analyzes the observation values of the measuring device, uses target values to evaluate the state of the system described by the observation values, and selects appropriate action values in order to control the adjustment device and thereby achieve the target values.

### BACKGROUND

In a known control loop of type mentioned in the Technical Field section of this disclosure, the regulator mainly processes measured data relating to mass flows, temperature distributions and flame images. In order to obtain better regulating results, it makes sense first of all to gather as much information as possible about the state of the system. The data are scalars from which, using a neural network, predictions of future states are calculated. Depending on the type of installation, it may prove sensible to reduce the amount of data in order to have computing capacity available for longer-term predictions.

### BRIEF SUMMARY OF SOME ASPECTS OF THIS DISCLOSURE

An aspect of this disclosure is the provision of improvements that relate to a control loop of the type mentioned in the Technical Field section of this disclosure. In accordance with one aspect of this disclosure, a control loop, which is for regulating a process in a plant having a controlled system, comprises at least one measuring device for recording observation values of the controlled system, at least one adjustment device for acting on the controlled system in response to the adjustment device being controlled by way of action values, and a regulator operably connected to both the measuring device and the adjustment device. The regulator is operative for providing the action values. In this regard, the regulator may be adapted for: predicting, by way of a process model and at least one probability distribution of the observation values, a set of distributions of probable future states of the system; evaluating the set of distributions of probable future states of the system using target values and/or distributions of the target values; and selecting at least one probability distribution of action values. More specifically, the process may be a combustion process, and the plant may be a power-generating plant, a waste-treatment/incineration plant or a cement plant. The process model may be stored in a process model unit of the regulator. The evaluating of the set of distributions of probable future states of the system may occur in an evaluation unit of the regulator. The selecting of the at least one probability distribution of action values may occur in a selection unit of the regulator.

Stochastic aspects of the process can be taken into account because, using a process model, the regulator predicts a set of distributions of probable future states of the system from at least one probability distribution of the observation values; it then evaluates these states on the basis of the target values and/or their distributions and selects at least one probability distribution of the suitable action values. Not only individual scalar mean values are processed but also, with the aid of the probability distributions, it is possible to estimate in each case the most probable measurements and prediction values as well as the uncertainty of the respective prediction. Searching for states across the whole range of all possible values is replaced by the targeted use of a few characteristic values of the probability distributions. As a result, regulation is improved, and in particular it is faster and more accurate. Up until now, such Bayesian statistics have not been used in process technology or in neural networks. The memory required for the probability distributions can be reduced by appropriate approximations. The units of the regulator may be logical or structural units.

The present invention may be used in various stationary thermodynamic installations, in particular in coal-fired, oil-fired or gas-fired power-generating plants, waste-incineration, waste-separation or waste-sorting plants and cement plants.

Other aspects and advantages of the present invention will become apparent from the following.

### BRIEF DESCRIPTION OF THE DRAWINGS

The present invention is described in more detail below on the basis of an exemplary embodiment depicted in the drawings, in which:

FIG. 1 is a block circuit diagram of a regulator in operation,

FIG. 2 is a block circuit diagram of a regulator being trained,

FIG. 3 is a diagrammatic view of the exemplary embodiment, and

FIG. 4 is a diagrammatic view of a probability distribution.

### DETAILED DESCRIPTION OF EXEMPLARY EMBODIMENT

In the exemplary embodiment, a plant 1 is provided that is intended to be regulated by way of a control loop. The plant 1 comprises a controlled system 3, at least one and preferably (e.g., optionally) several different measuring devices 5 that record the measurement data of the controlled system 3, at least one and preferably (e.g., optionally) several different adjustment devices 9 that can act upon the controlled system 3, and a regulator 11 that is operably connected in any suitable manner (e.g., by wire(s), cable(s) and/or signal(s) provided without wires or cables) to both the measuring device(s) 5 and the adjustment device(s) 9, thereby forming the control loop.

The controlled system 3 is supplied with material to be converted, referred to as material G for short, for example fuels such as coal, oil, gas, other primary fuels, waste or other secondary fuels (also lime, in the case of the system 3 being for making cement/the system 3 being a cement plant), as well as primary air (primary oxygen) and secondary air (secondary oxygen), referred to as air L for short, and this supply is controlled by the adjustment devices 9 that are regulated by the regulator 11. The core of the controlled system 3 consists of a furnace 13 in which a combustion process takes place. The measuring devices 5 record as many measurements as possible of the controlled system 3, for example images of the flame body F produced by the combustion process, possibly also emissions from the walls of the furnace 13, other thermal images, temperatures, pressures, mass flows of material G, of air L, and also measurements of the cooling cement and waste gases in the case of a cement plant, and measurements of pollutant concentrations in the waste gases, and in the case of a cement plant the concentration of free lime (FCAO) as a measure of quality of the cement.

The regulator 11 has at least one and preferably (e.g., optionally) several input converters 11a, a process model unit 11b, an evaluation unit 11c, a selection unit 11d, an output converter 11e and an action generator 11f. The regulator 11 preferably (e.g., optionally) also has a conventional regulating unit 11g that is connected in parallel to the other components mentioned.

The measurements recorded by the measuring devices 5, which are referred to in the following as observation values x, are state variables that describe the actual state of the system as a function of time, i.e. x=x(t). In the associated input converter 11a, probability distributions P=P(x) are formed from these time-dependent observation values x. For this purpose, in the simplest case, the relevant value range of an observation value x, for example a temperature in the furnace 13, is subdivided into individual steps, and over a certain time interval this observation value x is measured and P(x) is determined via the individual steps as the frequency of the individual measurements of x(t) (histogram with nodes). In the simplest case of an on average constant observation value x, a discretized Gaussian normal distribution is obtained due to fluctuations and other statistical phenomena. The actual state of the system is then described by the totality of the probability distributions P=P(x) and input into the process model unit 11b. At least one process model, and preferably (e.g., optionally) several inter-competing process models, is or are stored in the process model unit 11b. The process model(s) are preferably (e.g., optionally) implemented in the form of a neural network.

An action generator 11f generates a set {zᵢ} of possible action values. These may be selected randomly (Monte Carlo) or on the basis of an evaluation strategy. From the set {zᵢ} of possible action values, another (or the same) input converter 11a forms a set {P(zᵢ)} of associated distributions. These distributions are determined in the same way as those for the observation values x. The set {P(zᵢ)} of distributions assigned to the possible action values is also input into the process model unit 11b.

The so-called Bayesian process model contained in the process model unit 11b is originally trained in a manner that will be described further below and it is preferably (e.g., optionally) continuously improved; using this Bayesian process model, predictions about probable future (actual) states of the system are made from the distributions P(x) and {P(zᵢ)}, and the predictions are expressed in the form of a set {P(yᵢ)} of assigned distributions and input into an evaluation unit 11c. Target values y, i.e. predetermined setpoint values and other optimization targets, such as a lower consumption of primary fuel or waste gases low in residues, in particular low pollution concentrations, are also input into the evaluation unit 11c, either directly or preferably (e.g., optionally) after conversion into a probability distribution P=P(y). The evaluation unit 11c evaluates the set {P(yᵢ)} of distributions of probable future states of the system with regard to the probability distribution P(y) of the target values y. The individual evaluation can be expressed by a quality qᵢ, for example a scalar, so that the evaluation unit 11c outputs a set {qⱼ} of qualities. The selection unit 11d selects the maximum quality qᵢ, in general the qᵢ with the largest numerical value, and from the set {P(zᵢ)} takes the distribution responsible for this qᵢ as a suitable probability distribution P=P(z) of action values z that should bring the state of the system closer to the target values y or P(y).

In the output converter 11e individual action values z are formed from the probability distributions P=P(z), to which concrete actions are assigned and on the basis of which (e.g., in response to which) the controlled adjustment devices 9 then carry out the assigned actions. The control loop is thereby closed. In the simplest case of a Gaussian normal distribution P=P(z), for example for a valve setting, a concrete (e.g., specific) valve setting corresponding to the peak value is obtained. The centroid or similar may also be used. In a more complicated case a sequence of settings will result, i.e. a sequence of action values z which are matched to one another.

The conventional regulator unit 11g, which may perhaps be additionally provided, may assume part of the regulatory function for individual adjustment devices 9 or as a substitute unit in emergency situations or other cases, thereby bypassing the input converter 11a, the process model unit 11b, the evaluation unit 11c, the selection unit 11d and the output converter 11e as well as the action generator 11f.

The use of the probability distribution P makes it possible to take better account of stochastic aspects and properties, i.e. apart from an individual value, for example the most probable predicted value, the associated uncertainties are also included, for example the scatter of this predicted value. The process model for the probability distributions is preferably (e.g., optionally) structured in such a way that the process model may be used iteratively for multi-step predictions and bi-directionally for forward and parallel backward calculations. When the scatter is known, sensible termination criteria can also be chosen for the multi-step predictions.

Because of the highly non-linear relationships in the system, in general instead of the Gaussian normal distribution, a more complicated probability distribution P will in each case occur, which may quite possibly contain several local maxima. Because the present invention can be used to evaluate targeted observation values x and to select action values z, this makes it possible to approach the target values y more rapidly.

In order to train the process model in the process model unit 11b, the observation values x and the actual action values z are converted in the associated input converters 11a into distributions P(x) and P(z) that are input into the process model unit 11b. The set {P(yᵢ)} of distributions of probable future actual states of the system is also input into the evaluation unit 11c, like the distribution P(y) of the target values y. The prediction error that is determined is used, in the known manner, to adapt the process model, for example to adapt the links in the neural network. It is possible that inter-competing process models and/or inter-competing regulators may be trained simultaneously.

To permit sensible processing, the very high-dimensional probability distributions (probability density distributions) should not be stored in highly resolved form but should be approximated, for example by parametric probability distributions (characterized by a few characteristic parameters), by “graphical models” (characterized by a few functions from a functions system), by a particle filter (Monte Carlo method), or they should be stored by the neural network used (e.g. a radial basis function network).

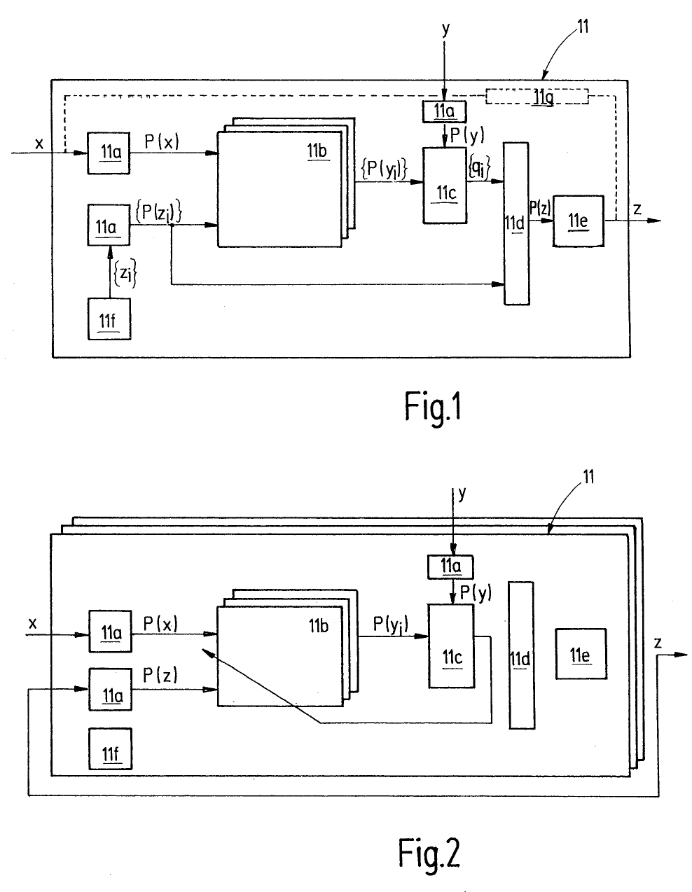

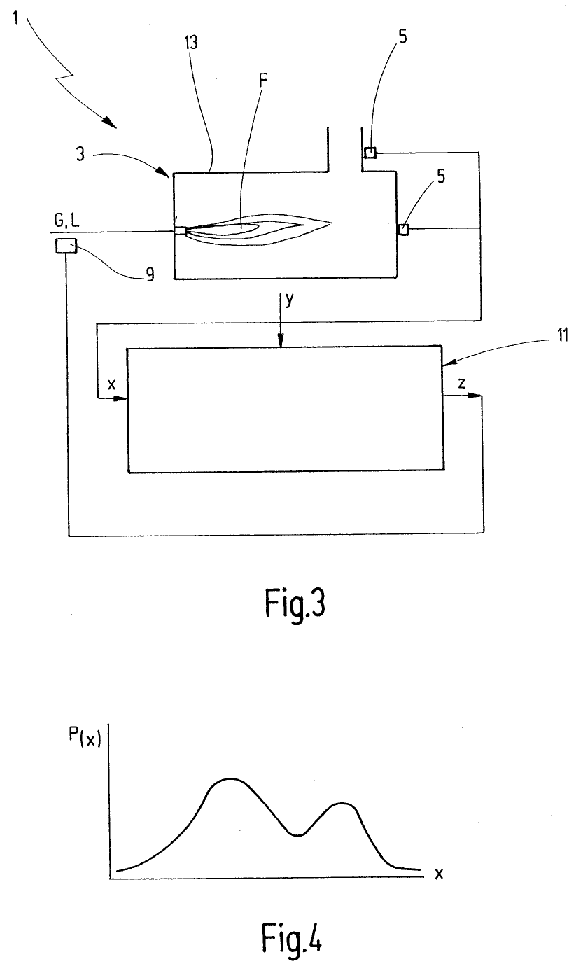

Generally described and in accordance with the exemplary embodiment of this disclosure, the regulator 11 may be embodied in software, firmware and/or hardware, such that FIGS. 1 and 2 can be characterized as being schematically illustrative of at least one computer (which includes appropriate input and output devices, a processor, memory, etc.) for controlling the operation of the plant 1 by virtue of receiving data from and providing data (e.g., instructions from the execution of software modules stored in memory) to respective components 5, 9. For this purpose and in accordance with the exemplary embodiment of this disclosure, the computer(s) typically include or are otherwise associated with one or more computer-readable mediums (e.g., nonvolatile memory and/or volatile memory such as, but not limited to, flash memory, tapes and hard disks such as floppy disks and compact disks, or any other suitable storage devices) having computer-executable instructions (e.g., one or more software modules or the like), with the computer(s) handling (e.g., processing) the data in the manner indicated by the computer-executable instructions. Accordingly, FIGS. 1 and 2 can be characterized as being schematically illustrative of the computer-readable mediums, computer-executable instructions and other features of methods and systems of the exemplary embodiment of this disclosure.

It will be understood by those skilled in the art that while the present invention has been discussed above with reference to an exemplary embodiment, various additions, modifications and changes can be made thereto without departing from the spirit and scope of the invention as set forth in the claims.

That which is claimed:

1. A control loop for regulating a process in a plant having a controlled system, the control loop comprising:
at least one measuring device for recording observation values of the controlled system;
at least one adjustment device for acting on the controlled system in response to the adjustment device being controlled by way of action values; and
a regulator operably connected to both the measuring device and the adjustment device, wherein the regulator is operative to provide the action values, and the regulator being operative to provide the action values comprises the regulator being adapted for
predicting, by way of a process model and at least one probability distribution of the observation values, a set of distributions of probable future states of the system,
evaluating the set of distributions of probable future states of the system using target values and/or distributions of the target values, and
selecting at least one probability distribution of action values.

2. The control loop according to claim 1, wherein the regulator has an input converter that creates the at least one probability distribution from the observation values.

3. The control loop according to claim 1, wherein the regulator has an output converter that creates the action values from the at least one probability distribution of action values.

4. The control loop according to claim 2, further comprising a conventional regulating unit, wherein:
the regulator has an output converter that creates the action values from the at least one probability distribution of action values; and
the conventional regulating unit bypasses each of
the input converter of the regulator, and
the output converter of the regulator.

5. The control loop according to claim 1, comprising:
the regulator having a process model unit;
the process model being stored in the process model unit;
an action generator for generating a set of possible action values; and
an input converter for forming, from the set of possible action values, a set of assigned distributions that are input into the process model unit.

6. The control loop according to claim 1, wherein:
the regulator comprises an evaluation unit;
the evaluating of the set of distributions of probable future states of the system is carried out in the evaluation unit; and
the evaluation unit evaluates, by way of a quality, the set of distributions of probable future states of the system based on the target values and/or the distributions of the target values.

7. The control loop according to claim 1, wherein the regulator comprises a process model unit, and the process model is implemented as a neural network in the process model unit.

8. The control loop according to claim 1, wherein the regulator comprises a process model unit, and the process model is configured for forward and backward calculation in the process model unit.

9. The control loop according to claim 1, wherein the processes is a combustion process, and the controlled system has a furnace for converting material by way of the combustion process, with at least oxygen being supplied and at least one flame body being formed.

10. The control loop according to claim 9, wherein the adjustment device acts on the controlled system by controlling a supply of the material and/or a supply of the oxygen.

11. The control loop according to claim 1, wherein:
the process is a combustion process in a power-generating plant, a waste-treatment/incineration plant or a cement plant;
the regulator comprises a process model unit, an evaluation unit and a selection unit;
the process model is stored in the process model unit;
the evaluating of the set of distributions of probable future states of the system is carried out in the evaluation unit; and
the selecting of the at least one probability distribution of action values is carried out in the selection unit.

12. The control loop according to claim 11, wherein the regulator has an input converter that creates the at least one probability distribution from the observation values.

13. The control loop according to claim 12, wherein the regulator has an output converter that creates the action values using the at least one probability distribution of action values.

14. The control loop according to claim 13, further comprising a conventional regulating unit, wherein the conventional regulating unit bypasses each of:
the input converter of the regulator,
the process model unit of the regulator,
the evaluation unit of the regulator,
the selection unit of the regulator, and
the output converter of the regulator.

15. The control loop according to claim 13, wherein the evaluation unit evaluates, by way of a quality, the set of distributions of probable future states of the system based on the target values and/or the distributions of the target values.

16. The control loop according to claim 13, wherein the process model is implemented as a neural network in the process model unit, and the process model is configured for forward and backward calculation in the process model unit.

17. The control loop according to claim 13, wherein:
the process is a combustion process;
the controlled system has a furnace for converting material by way of the combustion process, with at least oxygen being supplied to the furnace and at least one flame body being formed in the furnace; and
the adjustment device acts on the controlled system by controlling a supply of the material and/or a supply of the oxygen.

18. A method for regulating a process in a plant having a controlled system, at least one measuring device for recording observation values of the controlled system, and at least one adjustment device for acting on the controlled system in response to the adjustment device being controlled by way of action values, the method comprising:
creating at least one probability distribution at least from the observation values;
predicting, by way of a process model and the at least one probability distribution, a set of distributions of probable future states of the system;
evaluating the set of distributions of probable future states of the system using target values and/or distributions of the target values;
selecting at least one probability distribution of action values; and
creating the action values using the at least one probability distribution of action values.

19. The method according to claim 18, wherein the evaluating of the set of distributions of probable future states of the system comprises:
evaluating, by way of a quality, the set of distributions of probable future states of the system based on the target values and/or the distributions of the target values.
